(19) United States
(12) Patent Application Publication
(10) Pub. No.: US 2002/0118742 A1
(43) Pub. Date: Aug. 29, 2002

(54) Prediction structures for enhancement layer in fine granular scalability video coding

(75) Inventors: Atul Puri, Riverdale, NY (US); Yingwei Chen, Ossining, NY (US); Hayder Radha, Mahwah, NJ (US)

Correspondence Address: Michael E. Marion, Corporate Patent Counsel, Philips Electronics North America Corporation, 580 White Plains Road, Tarrytown, NY, 10591, US

(73) Assignee: PHILIPS ELECTRONICS NORTH AMERICA CORPORATION.

(21) Appl. No.: 09/793,035

(22) Filed: Feb. 26, 2001

(51) Int. Cl. H04N 7/12

(52) U.S. Cl. 375/240.1; 375/240.12

(57) ABSTRACT

The present invention is directed to a technique for flexibly and efficiently coding of video data. The technique involves coding of a portion of the video data called base layer frames and coding of residual images generated from the video data and the prediction signal. The prediction for each video frame is generated using multiple decoded base layer frames and may use motion compensation. The residual images are called enhancement layer frames and are then coded. Based on this technique, since a wider locality of base layer frames are utilized, better prediction can be obtained. Since the resulting residual data in enhancement layer frames is small, they can be efficiently coded. For coding of enhancement layer frames, fine granular scalability techniques (such as DCT transform coding or wavelet coding) are employed. The decoding process is reverse of encoding process. Therefore, flexible, yet efficient coding and decoding of video is accomplished.

### BACKGROUND OF THE INVENTION

The present invention generally relates to video compression, and more particularly to a scalability structure that utilizes multiple base layer frames to produce each of the enhancement layer frames.

Scalable video coding is a desirable feature for many multimedia applications and services. For example, video Unscalability is utilized in systems employing decoders with a wide range of processing power. In this case, processors with low computational power decode only a subset of the scalable video stream.

Another use of scalable video is in environments with a variable transmission bandwidth. In this case, receivers with low-access bandwidth, receive and consequently decode only a subset of the scalable video stream, where the amount of this subset of the scalable video stream is proportional to the available bandwidth.

Several video scalability approaches have been adopted by lead video compression standards such as MPEG-2 and MPEG-4. Temporal, spatial, and quality (SNR) scalability types have been defined in these standards. All of these approaches consist of a Base Layer (BL) and an Enhancement Layer (EL). The BL part of the scalable video stream represents, in general, the minimum amount of data required for decoding the video stream. The EL part of the stream represents additional information that is used to enhance the video signal representation when decoded by the receiver.

Another class of scalability utilized for coding still images is fine-granular scalability (FGS). Images coded with this type of scalability are decoded progressively. In other words, the decoder starts decoding and displaying the image before receiving all of the data used for coding the image. As more data is received, the quality of the decoded image is progressively enhanced until all of the data used for coding the image is received, decoded, and displayed.

Fine-granular scalability for video is under active standardization within MPEG-4, which is the next-generation multimedia international standard. In this type of scalability structure, motion prediction based coding is used in the BL as normally done in other common video scalability methods. For each coded BL frame, a residual image is then computed and coded using a fine-granular scalability method to produce an enhancement layer frame. This structure eliminates the dependencies among the enhancement layer frames, and therefore enables fine-granular scalability, while taking advantage of prediction within the BL and consequently provides some coding efficiency.

An example of the FGS structure is shown in FIG. 1. As can be seen, this structure also consists of a BL and an EL. Further, each of the enhancement frames are produced from a temporally co-located original base layer frame. This is reflected by the single arrow pointing upward from each base layer frame upward to a corresponding enhancement layer frame.

An example of a FGS-based encoding system is shown in FIG. 2. The system includes a network 6 with a variable available bandwidth in the range of (Bₘᵢₙ=Rₘᵢₙ, Bₘₐₓ=Rₘₐₓ). A calculation block 4 is also included for estimating or measuring the current available bandwidth (R).

Further, a base layer (BL) video encoder 8 compresses the signal from the video source 2 using a bit-rate (R_{BL}) in the range (Rₘᵢₙ, R). Typically, the base layer encoder 8 compresses the signal using the minimum bit-rate (Rₘᵢₙ). This is especially the case when the BL encoding takes place off-line prior to the time of transmitting the video signal. As can be seen, a unit 10 is also included for computing the residual images 12.

An enhancement layer (EL) encoder 14 compresses the residual signal 12 with a bit-rate R_{EL}, which can be in the range of R_{BL} to Rₘₐₓ−R_{BL}. It is important to note that the encoding of the video signal (both enhancement and base layers) can take place either in real-time (as implied by the figure) or off-line prior to the time of transmission. In the latter case, the video can be stored and then transmitted (or streamed) at a later time using a real-time rate controller 16, as shown. The real time controller 16 selects the best quality enhancement layer signal taking into consideration the current (real-time) available bandwidth R. Therefore, the output bit-rate of the EL signal from the rate controller 16 equals, R−R_{BL}.

### SUMMARY OF THE INVENTION

The present invention is directed to a flexible yet efficient technique for coding of input video data. The method involves coding of a portion of the video data called base layer frames and enhancement layer frames. Base layer frames are coded by any of the motion compensated DCT coding techniques such as MPEG-4 or MPEG-2.

Residual images are generated by subtracting the prediction signal from the input video data. According to the present invention, the prediction is formed from multiple decoded base layer frames with or without motion compensation, where the mode selection decision is included in the coded stream. Due to efficiency of this type of prediction, the residual image data is relatively small. The residual images called enhancement layer frames are then coded using fine granular scalability (such as DCT transform coding or wavelet coding). Thus, flexible, yet efficient coding of video is accomplished.

The present invention is also directed to the method that reverses the aforementioned coding of video data, to generate decoded frames. The coded data consist of two portions, a base layer and an enhancement layer. The method includes the base layer being decoded depending on the coding method (MPEG-2 or MPEG-4 chosen at the encoder) to produce decoded base layer video frames. Also, the enhancement layer being decoded depending on the fine granular scalability (such as DCT transform coding or wavelet coding chosen at the encoder) to produce enhancement layer frames. As per the mode decision information in the coded stream, selected frames from among multiple decoded base layer video frames are used with or without motion compensation to generate the prediction signal. The prediction is then added to each of the decoded base layer video frames to produce decoded output video.

### BRIEF DESCRIPTION OF THE DRAWINGS

Referring now to the drawings were like reference numbers represent corresponding parts throughout:

FIG. 1 is a diagram of one scalability structure;

FIG. 2 is a block diagram of one encoding system;

FIG. 3 is a diagram of one example of the scalability structure according to the present invention;

FIG. 4 is a diagram of another example of the scalability structure according to the present invention;

FIG. 5 is a diagram of another example of the scalability structure according to the present invention;

FIG. 6 is a block diagram of one example of an encoder according to the present invention;

FIG. 7 is a block diagram of one example of a decoder according to the present invention; and

FIG. 8 is a block diagram of one example of a system according to the present invention.

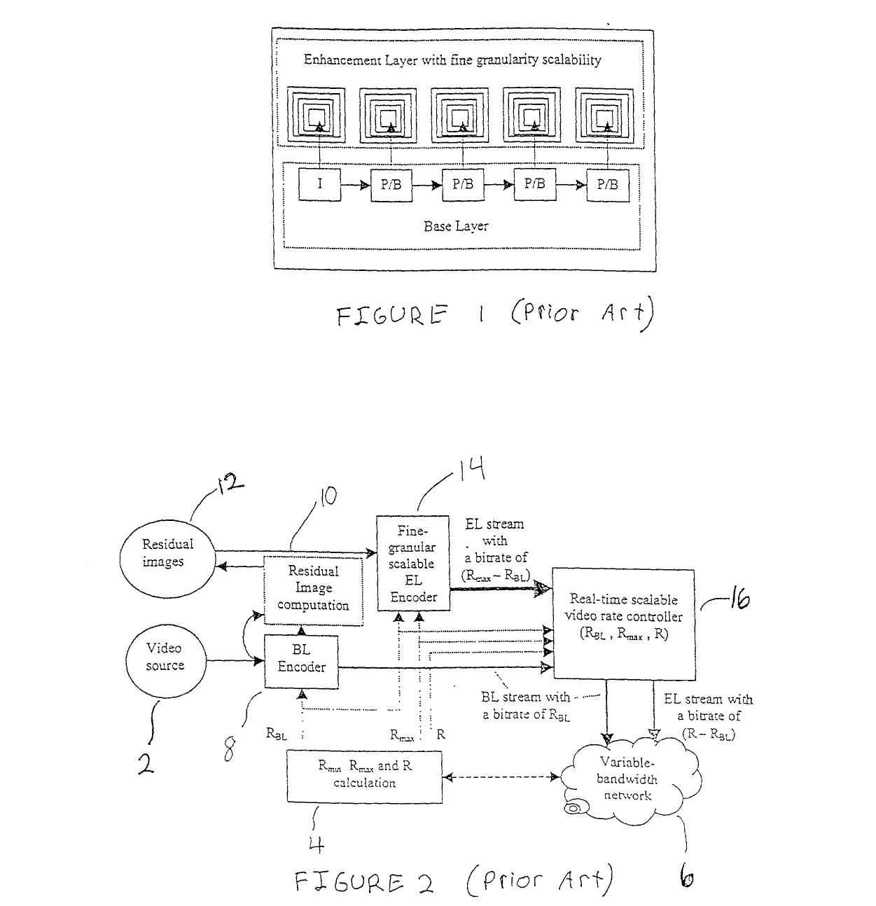

### DETAILED DESCRIPTION

In order to generate enhancement layer frames that are easy to compress, it is desirable to reduce the amount of information required to be coded and transmitted. In the current FGS enhancement scheme, this is accomplished by including prediction signals in the base layer. These prediction signals depend on the amount of base layer compression, which contain varying amounts of information from the original picture. The remaining information not conveyed by the base layer signal is then encoded by the enhancement layer encoder.

It is important to note that information relating to one particular original picture resides in more than the corresponding base layer coded frame, due to the high amount of temporal correlation between adjacent pictures. For example, a previous base layer frame may be compressed with a higher quality than the current one and the temporal correlation between the two original pictures may be very high. In this case, it is possible that the previous base layer frame carries more information about the current original picture than the current base layer frame. Therefore, it may be preferable to use a previous base layer frame to compute the enhancement layer signal for this picture.

As previously discussed in regard to FIG. 1, the current FGS structure produces each of the enhancement layer frames from a corresponding temporally located base layer frame. Though relatively low in complexity, this structure excludes possible exploitation of information available in a wider locality of base layer frames, which may be able to produce a better enhancement signal. Therefore, according to the present invention, using a wider locality of base layer pictures may serve as a better source for generating the enhancement layer frames for any particular picture, as compared to a single temporally co-located base layer frame.

The difference between the current and the new scalability structure is illustrated through the following mathematical formulation. The current enhancement structure is illustrated by the following:

E(t)=O(t)−B(t), (1)

there E(t) is the enhancement layer signal, O(t) is the original Picture, and B(t) is the base layer encoded picture at time “t”. The new enhancement structure according to the present invention is illustrated by the following:

E(t)=O(t)−sum {a(t−i)*M(B(t−i))}

i=L1, −L1+1, . . . , 0, 1, . . . , L2−1, L2 (2)

where L1 and L2 are the “locality” parameters, and a(t−i) is the weighting parameter given to each base layer picture. The weighting a(t−i) is constrained as follows:

0<=a(t−i)<+1

Sum{a(t−i)}=1

i=−L1, −L1+1, . . . , 0, 1, . . . , L2−1, L2 (3)

Further, the weighting parameter a(t−i) of Equation (2) is also preferable chosen to minimize the size of the Enhancement layer signal E(t). This computation is performed in the enhancement layer residual computation unit. However, if the amount of computing power necessary to perform this calculation is not available, then the weighting parameter a(t−i) may be either toggled between 0 and 1 or averaged to a(t+1)=0.5 or a(t−1)=0.5.

The M operator in Equation (2) denotes a motion estimation operation performed, as corresponding parts in neighboring pictures or frames are usually not co-located due to motion in the video. Thus, the motion estimation operation is performed on neighboring base layer pictures or frames in order to produce motion compensation (MC) information for the enhancement layer signal defined in Equation 2. Typically, the MC information includes motion vectors and any difference information between neighboring pictures.

According to the present invention, there are several alternatives for computing, using, and sending the Motion Compensation (MC) information for the enhancement layer signal produced according to Equation (2). For example, the MC information used in the M operator can be identical to the MC information (e.g., motion vectors) computed by the base layer. However, there are cases when the base-layer does not have the desired MC information.

For example, when Backward prediction is used, then Backward MC information has to be computed and transmitted if such information were not computed and transmitted as part of the base-layer (e.g., if the base-layer only consists of I and P pictures but no B pictures). Based on the amount of motion information that needs to be computed and transmitted in addition what is required for the base layer, there are three possible scenarios.

In one possible scenario, the additional complexity that is involved in computing a separate set of motion vectors for just enhancement layer prediction is not of significant concern. This option, theoretically speaking, should give the best enhancement layer signal for subsequent compression.

In a second possible scenario, the enhancement layer prediction uses only the motion-vectors that have been computed at the base-layer. The source pictures (where prediction is performed from) for enhancement layer prediction for a particular picture must be a subset of the ones that are used in the base layer for the same picture. For example, if the base layer is an intra picture, then its enhancement layer can only be predicted from the same intra base picture. If the base layer is a P picture, then its enhancement picture has to be predicted from the same reference pictures that are used for the base layer motion prediction and the same goes for B pictures.

The second scenario described above may constrain the type of prediction that may be used for the enhancement layer. However, it does not require the transmission of extra motion vectors and eliminates the need for computing any extra motion vectors. Therefore, this keeps the encoder complexity low with probably just a small penalty in quality.

A third possible scenario is somewhere between the first two scenarios. In this scenario, little or no constraint is put on the type of prediction that the enhancement layer can use. For the pictures that happen to have the base layer motion vectors available for the desired type of enhancement prediction, the base motion vectors are re-used. For the other pictures, the motion vectors are computed separately for enhancement prediction.

The above-described formulation gives a general framework for the computation of the enhancement layer signal. However, several particulars of the general framework are worth noting here. For example, if L1=L2=0 in Equation (2), the new FGS enhancement prediction structure reduces to the current FGS enhancement prediction structure shown in FIG. 1. It should be noted that the functionality provided by the new structure is not impaired in any way by the proposed improvements here, since the relationship among the enhancement layer pictures is not changed since enhancement layer pictures are not derived from each other.

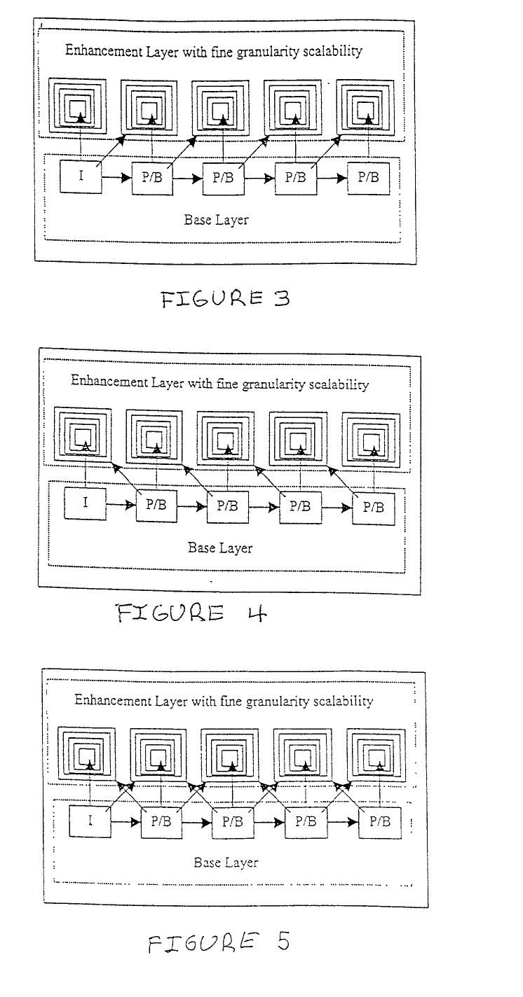

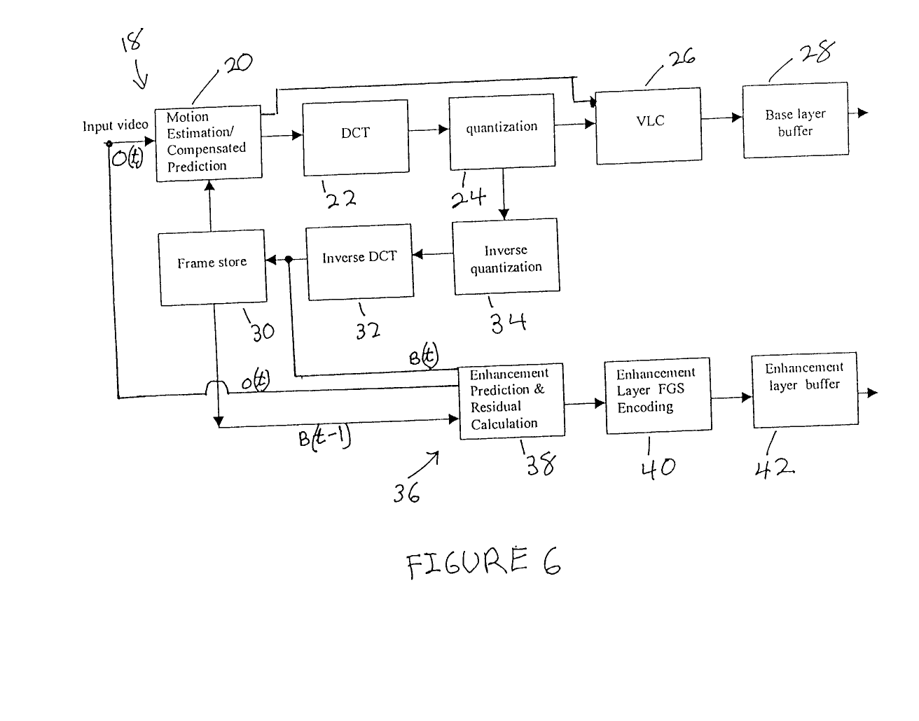

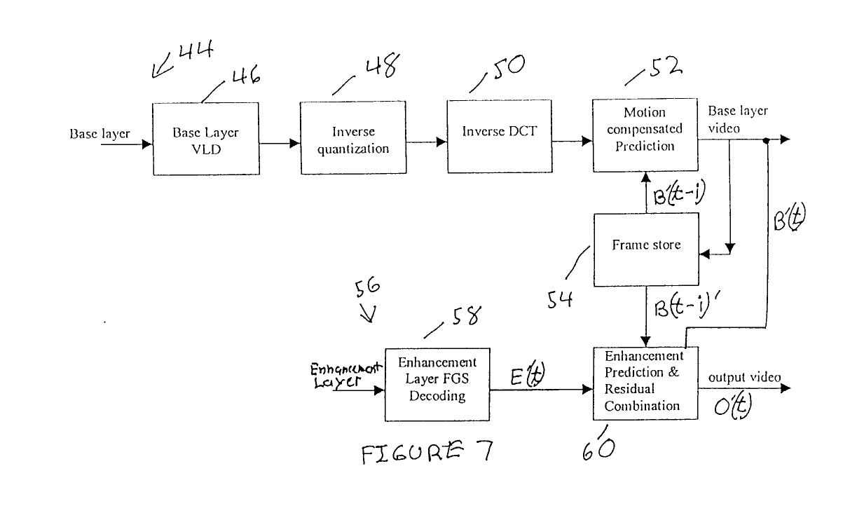

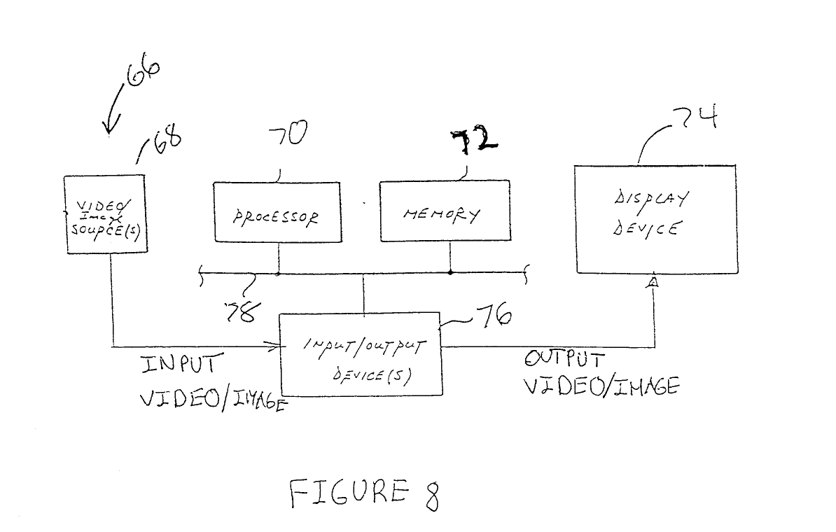

Further, if L1=0 and L2=1 in Equation (2), the general framework reduces to the scalability structure shown in FIG. 3. In this example of the scalability structure according to the present invention, a temporally located as well as a subsequent base layer frame is used to produce each of the enhancement layer frames. Therefore, the M operator in Equation (2) will perform forward prediction.

Similarly, if or L1=1 and L2=0 in Equation (2), the general framework reduces to the scalability structure shown in FIG. 4. In this example of the scalability structure according to the present invention, a temporally located as well as a previous base layer frame is used to produce each of the enhancement layer frames. Therefore, the M operator in Equation (2) will perform backward prediction.

Moreover, if L1=L2=1 in Equation (2), the general framework reduces to the scalability structure shown in FIG. 5. In this example of the scalability structure according to the present invention, a temporally located, a subsequent and previous base layer frame is used to produce each of the enhancement layer frames. Therefore, the M operator in Equation (2) will perform bi-directional prediction.

One example of an encoder according to the present invention is shown in FIG. 6. As can be seen, the encoder includes a base layer encoder 18 and an enhancement layer decoder 36. The base layer encoder 18 encodes a portion of the input video O(t) in order to produce a base layer signal. Further, the enhancement layer encoder 36 encodes the rest of the input video O(t) to produce an enhancement layer signal.

As can be seen, the base layer encoder 18 includes a motion estimation/compensated prediction block 20, a discrete cosine transform (DCT) block 22, a quantization block 24, a variable length coding (VLC) block 26 and a base layer buffer 28. During operation, the motion estimation/compensated prediction block 20 performs motion prediction on the input video O(t) to produce motion vectors and mode decisions on how to encode the data, which are passed along to the VLC block 26. Further, the motion estimation/compensated prediction block 20 also passes another portion of the input video O(t) unchanged to the DCT block 22. This portion corresponds to the input video O(t) that will be coded into I-frames and partial B and P-frames that were not coded into motion vectors.

The DCT block 22 performs a discrete cosine transform on the input video received from the motion estimation/compensated prediction block 20. Further, the quantization block 24 quantizes the output of the DCT block 22. The VLC block 26 performs variable length coding on the outputs of both the motion estimation/compensated prediction block 20 and the quantization block 24 in order to produce the base layer frames. The base layer frames are temporarily stored in the base layer bit buffer 28 before either being output for transmission in real time or stored for a longer duration of time.

As can be further seen, an inverse quantization block 34 and an inverse DCT block 32 is coupled in series to another output of the quantization block 24. During operation, these blocks 32, 34 provide a decoded version of a previous frame coded, which is stored in a frame store 30. This decoded frame is used by the motion estimation/compensated prediction block 20 to produce the motion vectors for a current frame. The use of the decoded version of the previous frame enables the motion compensation performed on the decoder side to be more accurate since it is the same as received on the decoder side.

As can be further seen from FIG. 6, the enhancement layer encoder 36 includes an enhancement prediction and residual calculation block 38, an enhancement layer FGS encoding block 40 and an enhancement layer buffer 42. During operation, the enhancement prediction and residual calculation block 38 produces residual images by subtracting a prediction signal from the input video O(t).

According to the present invention, the prediction signal is formed from multiple base layer frames B(t), B(t−i) according to Equation (2). As previously described, B(t) represents a temporally located base layer frame and B(t−i) represents one or more adjacent base layer frames such as a previous frame, subsequent frame or both. Therefore, each of the residual images is formed utilizing multiple base layer frames.

Further, the enhancement layer FGS encoding block 40 is utilized to encode the residual images produced by the enhancement prediction and residual calculation block 38 in order to produce the enhancement layer frames. The coding technique used by the enhancement layer encoding block 40 may be any fine granular scalability coding technique such as DCT transform or wavelet image coding. The enhancement layer frames are also temporarily stored in a enhancement layer bit buffer 42 before either being output for transmission in real time or stored for a longer duration of time.

One example of a decoder according to the present invention is shown in FIG. 7. As can be seen, the decoder includes a base layer decoder 44 and an enhancement layer decoder 56. The base layer decoder 44 decodes the incoming base layer frames in order to produce base layer video B′ (t). Further, the enhancement layer decoder 56 decodes the incoming enhancement layer frames and combines these frames with the appropriate decoded base layer frames in order to produce enhanced output video O′ (t).

As can be seen, the base layer decoder 44 includes a variable length decoding (VLD) block 46, an inverse quantization block 48 and an inverse DCT block 50. During operation, these blocks 46, 48, 50 respectively perform variable length decoding, inverse quantization and an inverse discrete cosine transform on the incoming base layer frames to produce decoded motion vectors, I-frames, partial B and P-frames.

The base layer decoder 44 also includes a motion compensated prediction block 52 for performing motion compensation on the output of the inverse DCT block 50 in order to produce the base layer video. Further, a frame store 54 is included for storing previously decoded base layer frames B′ (t−i). This will enable motion compensation to be performed on partial B or P-frame based on the decoded motion vectors and the base layer frames B′ (t−i) stored in the frame store 54.

As can be seen, the enhancement layer decoder 56 includes an enhancement layer FGS decoding block 58 and an enhancement prediction and residual combination block 60. During operation, the enhancement layer FGS decoding block 58 decodes the incoming enhancement layer frames. The type of decoding performed is the inverse of the operation performed on the encoder side that may include any fine granular scalability technique such as DCT transform or wavelet image decoding.

Further, the enhancement prediction and residual combination block 60 combines the decoded enhancement layer frames E′ (t) with the base layer video B′ (t), B′ (t−i) in order to generate the enhanced video O′ (t). In particular, each of the decoded enhancement layer frames E′ (t) is combined with a prediction signal. According to the present invention, the prediction signal is formed from a temporally located base layer frame B′ (t) and at least one other base layer frame B′ (t−i) stored in the frame store 54. According to the present invention, the other base layer frame may be an adjacent frame such as a pervious frame, a subsequent frame or both. These frames are combined according to the following equation:

O′(t)=E′(t)+sum {a(t−i)*M(B′(t−i))}

i=−L1, −L1+1, . . . , 0, 1, . . . , L2−1, L2, (4)

where the M operator denotes a motion displacement or compensation operator and a(t−i)denotes a weighting parameter. The operations performed in equation (4) are the inverse of the operations performed on the decoder side as shown in Equation (2). As can be seen, these operations include adding each of the decoded enhancement layer frames E′ (t) to a weighted sum of motion compensated base layer video frames.

One example of a system in which the present invention may be implemented is shown in FIG. 8. By way of example, the system 66 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system 66 includes one or more video sources 68, one or more input/output devices 76, a processor 70 and a memory 72.

The video/image source(s) 68 may represent, e.g., a television receiver, a VCR or other video/image storage device. The source(s) 68 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 76, processor 70 and memory 72 communicate over a communication medium 78. The communication medium 78 may represent, e.g., a bus, a communication network, one or more internal connections of a circuit, circuit card or other device, as well as portions and combinations of these and other communication media. Input video data from the source(s) 68 is processed in accordance with one or more software programs stored in memory 72 and executed by processor 70 in order to generate output video/images supplied to a display device 74.

In one embodiment, the coding and decoding employing the new scalability structure according to the present invention is implemented by computer readable code executed by the system. The code may be stored in the memory 72 or read/downloaded from a memory medium such as a CD-ROM or floppy disk. In other embodiments, hardware circuitry may be used in place of, or in combination with, software instructions to implement the invention. For example, the elements shown in FIGS. 6-7 also may be implemented as discrete hardware elements.

While the present invention has been described above in terms of specific examples, it is to be understood that the invention is not intended to be confined or limited to the examples disclosed herein. For example, the invention is not limited to any specific coding strategy frame type or probability distribution. On the contrary, the present invention is intended to cover various structures and modifications thereof included within the spirit and scope of the appended claims.

What is claimed is:

1. A method for coding video data, comprising the steps of:
coding a portion of the video data to produce base layer frames;
generating residual images from the video data and the base layer frames utilizing multiple base layer frames for each of the residual images; and
coding the residual images with a fine granular scalability technique to produce enhancement layer frames.

2. The method of claim 1, wherein the multiple base layer frames include a temporally located base layer frame and at least one adjacent base layer frame.

3. The method of claim 1, wherein each of the residual images is generated by subtracting a prediction signal from the video data, where the prediction signal is formed by the multiple base layer frames.

4. The method of claim 3, wherein the prediction signal is produced by the following steps:
performing motion estimation on each of the base layer frames;
weighting each of the base layer frames; and
summing the multiple base layer frames.

5. A method of decoding a video signal including a base layer and an enhancement layer, comprising the steps of:
decoding the base layer to produce base layer video frames;
decoding the enhancement layer with a fine granular scalability technique to produce enhancement layer video frames; and
combining each of the enhancement layer video frames with multiple base layer video frames to produce output video.

6. The method of claim 5, wherein the multiple base layer video frames include a temporally located base layer video frame and at least one adjacent base layer video frame.

7. The method of claim 5, wherein the combining step is performed by adding each of the enhancement layer video frames to a prediction signal, where the prediction signal is formed by the multiple base layer video frames.

8. The method of claim 7, wherein the prediction signal is produced by the following steps:
performing motion compensation on each of the base layer video frames;
weighting each of the base layer video frames; and
summing the multiple base layer video frames.

9. An apparatus for coding video data, comprising:
a first encoder for coding a portion of the video data to produce base layer frames;
an enhancement prediction and residual calculation block for generating residual images from the video data and the base layer frames utilizing multiple base layer frames for each of the residual images; and
a second encoder for coding the residual images with a fine granular scalability technique to produce enhancement layer frames.

10. An apparatus for decoding a video signal including a base layer and an enhancement layer, comprising the steps of:
a first decoder for decoding the base layer to produce base layer video frames;
a second decoder for decoding the enhancement layer with a fine granular scalability technique to produce enhancement layer video frames; and
an enhancement prediction and residual combination block for combining each of the enhancement layer video frames with multiple base layer video frames to produce output video.

11. A memory medium including code for encoding video data, the code comprising:
a code to encode a portion of the video data to produce base layer frames;
a code to generate residual images from the video data and the base layer frames utilizing multiple base layer frames for each of the residual images; and
a code to encode the residual images with a fine granular scalability technique to produce enhancement layer frames.

12. A memory medium including code for decoding a video signal including a base layer and an enhancement layer, the code comprising:
a code to decode the base layer to produce base layer video frames;
a code to decode the enhancement layer with a fine granular scalability technique to produce enhancement layer video frames; and
a code to combine each of the enhancement layer video frames with multiple base layer video frames to produce output video.
